(19) United States
(12) Patent Application Publication
(10) Pub. No.: US 2008/0316309 A1
(43) Pub. Date: Dec. 25, 2008

(54) Computer Network Security

(76) Inventor: Jason Andrew Roper, Alberton (ZA)

Correspondence Address: LADAS & PARRY LLP, 26 WEST 61ST STREET, NEW YORK, NY, 10023, US

(21) Appl. No.: 11/628,177

(22) PCT Filed: May 31, 2005
(86) PCT No.: PCT/IB05/01522

§ 371 Date: Feb. 4, 2008

(30) Foreign Application Priority Data
May 31, 2004 (ZA) 2004/4232
Aug. 23, 2004 (ZA) 2004/6678

(51) Int. Cl. H04N 7/18; G08B 21/00

(52) U.S. Cl. 348/143; 340/653; 348/E07.085

(57) ABSTRACT

The invention relates to a computer equipment security system (10) for securing computer equipment connected to a data communication network. The system (10) includes a plurality of surveillance units or agents (16) connected to respective computer devices (12) forming part of the data communication network. The security system (10) also includes a control station (18) which is in communication with each surveillance unit (16), the control station (18) being arranged for generating an alarm in response to interruption of the communication between the control station (18) and any one of the surveillance units (16). The invention also relates to a surveillance unit (16) for a workstation (12) of a computer network, and to a control station (18) for a computer equipment security system (10). The invention extends to a method of securing computer equipment which forms part of a computer network.

THIS INVENTION relates to computer network security. In particular, the invention relates to a computer equipment security system. The invention also relates to a surveillance unit for a workstation of a computer network, and to a control station for a computer equipment security system. The invention extends to a method of securing computer equipment which forms part of a computer network.

The invention provides a computer equipment security system for securing computer equipment connected to a data communication network, the security system including:
a plurality of surveillance units or agents connected to respective computer devices forming part of the data communication network;
a control station which is in communication with each surveillance unit, the control station being arranged for generating an alarm in response to interruption of the communication between the control station and any one of the surveillance units.

By computer device is meant a piece of computer equipment which is to be secured. Although each surveillance unit will typically be connected to a personal computer by being mounted inside a case of the computer, the surveillance units can also be connected to accessories or peripherals, such as printers, scanners, or the like.

It will be appreciated that the system may have a single control station to which all of the surveillance units are connected, or the system may have a plurality of control stations.

The system preferably includes a notification arrangement for automatically sending a notification message in response to the generation of an alarm by the control station. The notification arrangement is typically incorporated in the control station. In one embodiment of the invention the notification arrangement includes a telephonic messaging means for sending a telephonic text message, such an SMS message, to predetermined recipients. The telephonic text message is typically sent via an essentially wireless telephone network.

The control station is typically in communication with each surveillance unit via a wireless or a wired communication link, the control station being configured for automatically generating the alarm when the communication link is disconnected.

In a particular embodiment of the invention, the communication link between each surveillance unit and the control station is a wired link provided by a security network separate from the data communication network.

Instead, the communication link between each surveillance unit and the control station may be a wired link provided by the data communication network. In one case, the data communication network includes a plurality of multi-line cables connecting the control station to the respective surveillance units and/or computer devices, communication between the control station and the surveillance units being performed over spare conductors of the cables, the spare conductors not being used for the transmission of data by the data communication network.

In a particular embodiment of the invention, each multi-line cable comprises four twisted line pairs, two of the pairs being connected for the transmission of data by the data communication network, and the remaining two pairs connecting the control station to the respective surveillance units. One of the line pairs may thus provide the respective surveillance units with electrical power, the other pair being connected for communication between the control station and the surveillance units.

In an arrangement as defined above, the system can be viewed as having a data communication network and a separate security network, the physical layer of the security network being provided by spare lines on cables which provide the infrastructure for the data communication network.

Typically, each surveillance unit is connected to an associated personal computer (PC) at a workstation remote from the control station, the surveillance unit preferably being mounted in a case of the PC. In one embodiment of the invention, each surveillance unit may include a mating formation for cooperation with a PCI board expansion slot provided on a workstation. In other embodiments of the invention, the surveillance unit may be manufactured integrally with peripheral interfacing components by original equipment manufactures, so that each workstation, for example, has a dual-functional combo-PCI board providing a computer networking interface and the surveillance unit.

Each surveillance unit may include a sensing arrangement for detecting tampering with the associated workstation, each surveillance unit further including an alarm arrangement for sending an alarm signal to the control station in response to detecting tampering with the associated workstation. The sensing arrangement may, for instance include a light-sensitive sensor responsive to opening of the workstation case.

The control station is preferably arranged for generating an alarm either if it receives an alarm signal from one of the surveillance units, or if there is an interruption in communication between the control station and any one of the surveillance units.

Each surveillance unit typically has a processing unit, which may be provided by a microcontroller, the alarm arrangement preferably being configured for producing an audible alarm at the workstation, when tampering with the workstation is detected by the sensing arrangement. Each surveillance unit may include an onboard power backup for supplying electrical power to the sensing arrangement and the alarm arrangement if a main power supply to the surveillance unit fails.

In a preferred embodiment of the invention, each surveillance unit is operable between, on the one hand, an armed condition in which an alarm is automatically generated in response to detection of tampering with the workstation and/or a break in communication between the surveillance unit and the control station, and, on the other hand, an unarmed condition. The alarm arrangement is preferably arranged to produce an audible alarm if communication between the surveillance unit and the control station is interrupted while the surveillance unit is in its armed condition.

The control station may conveniently include a disarming arrangement for permitting remote switching of the respective surveillance units between their armed conditions and unarmed conditions, to enable performance of authorised maintenance of workstations without triggering an alarm. The control station may be connected in-line between the surveillance units and a hub of the data communication network. The control station typically has a central processing unit and a program memory which may be re-configurable by a user. To this end, the control station may include an input interface for connection to an input means, such as a keypad, and a display interface for connection to a display means, such as an LCD. Instead, the processing unit may be accessed by establishing a communication link between a serial communication port of a microcontroller which provides the processing unit, and a communication port of another computer, such as portable laptop computer.

Conveniently, the control station may be arranged for serving as a patch panel and/or for mounting in a server rack.

According to another aspect of the invention., there is provided a computer equipment security system for securing computer equipment connected to a data communication network, the security system including:
a plurality of surveillance units connected to respective computer devices forming part of the network;
a control station which is in communication with each surveillance unit; and
a notification arrangement for sending a notification message to at least one predetermined recipient in response to interruption of the communication between the control station and one of the surveillance devices, or in response to the reception by the control station of an alarm signal from one of the surveillance units.

As defined above, the notification arrangement may be configured for sending a telephonic text message as notification of the generation of an alarm, in which case the notification arrangement may include a cellular telephone transceiver, such as a GSM-module.

In another embodiment of the invention, the notification message may be in the form of a message sent to a plurality of recipients via a distributed communication network, such as the Internet.

The invention also provides a surveillance unit for a workstation connected to a data communication network, which surveillance unit includes:
an alarm arrangement which is operable between an armed condition and a disarmed condition;
a switching means for switching the alarm arrangement between its armed condition and its unarmed condition; and
a network connection arrangement for providing a data communication connection between the switching arrangement and a remote control station, to permit switching of the alarm arrangement between its armed condition and its disarmed condition from the control station.

The surveillance unit may include a detection arrangement for detecting tampering with the workstation, the alarm arrangement being arranged for automatically generating an alarm in response to the detection of tampering with the workstation, the alarm arrangement optionally being arranged to send an alarm signal to the control station when tampering with the workstation is detected.

The surveillance unit may include a monitoring means for monitoring the connection between the surveillance unit and the control station, the alarm arrangement being configured for generating an alarm in response to disruption of said connection. In one embodiment of the invention, the alarm arrangement is configured to generate an alarm in the form of an audible alarm at the workstation.

The surveillance unit may be as defined above with reference to a computer equipment security system.

According to a further aspect of the invention, there is provided a control station for a computer equipment security system, which control station includes:
a connection arrangement for connecting the control station to a plurality of surveillance units which are connected to respective computer devices forming part of a data communication network; and
a notification arrangement for notifying at least one predetermined recipient in response to interruption of communication between the control station and one of the surveillance units.

The notification arrangement may additionally be arranged to notify at least one predetermined recipient in response to reception by the control station of an alarm signal from one of the surveillance units.

Preferably, the control station includes a disarming arrangement for selectively switching the respective surveillance units between an armed condition and an unarmed condition.

As defined above with reference to a security system, the notification arrangement may be arranged for sending a notification message in the form of a telephonic text message.

The control station may be as defined above with reference to a computer equipment security system in accordance with the invention.

According to yet a further aspect of the invention, there is provided a method of securing a plurality of computer devices which are connected to a data communication network, which method includes:
providing a surveillance unit at each computer device which is to be secured, each surveillance unit being in communication with a central control station; and
monitoring communication between the control station and the surveillance units; and
automatically generating an alarm in response to an interruption in communication between any of the surveillance units and the control station.

The method may include detecting tampering with any of the computer devices by operation of the respective surveillance unit, and sending an alarm signal to the control station in response to the detection of such tampering.

Typically, generating an alarm includes generating an audible alarm at the relevant computer device.

The method may conveniently include switching a particular surveillance unit from an armed condition to an unarmed condition if authorised removal of or maintenance to the associated computer device is to occur.

Preferably, generating of the alarm includes sending a notification message to at least one predetermined recipient, the notification message optionally being in the form of a telephonic text message sent via a cellular telephone network.

The method may include connecting the control station to respective surveillance units by use of existing data communication network infrastructure, using spare conductors on network cables for communication between the control station and the surveillance units.

The invention will now be described by way of example with reference to the accompanying diagrammatic drawings, in which:

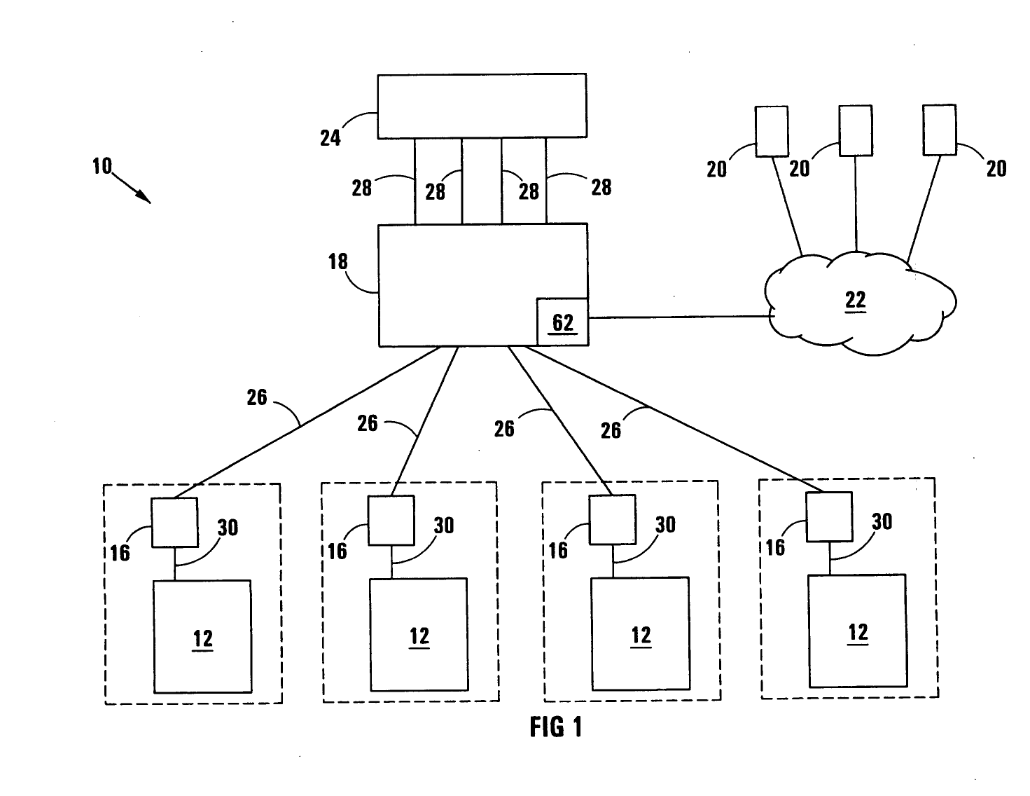

FIG. 1 is a schematic diagram of a computer equipment security system in accordance with the invention;

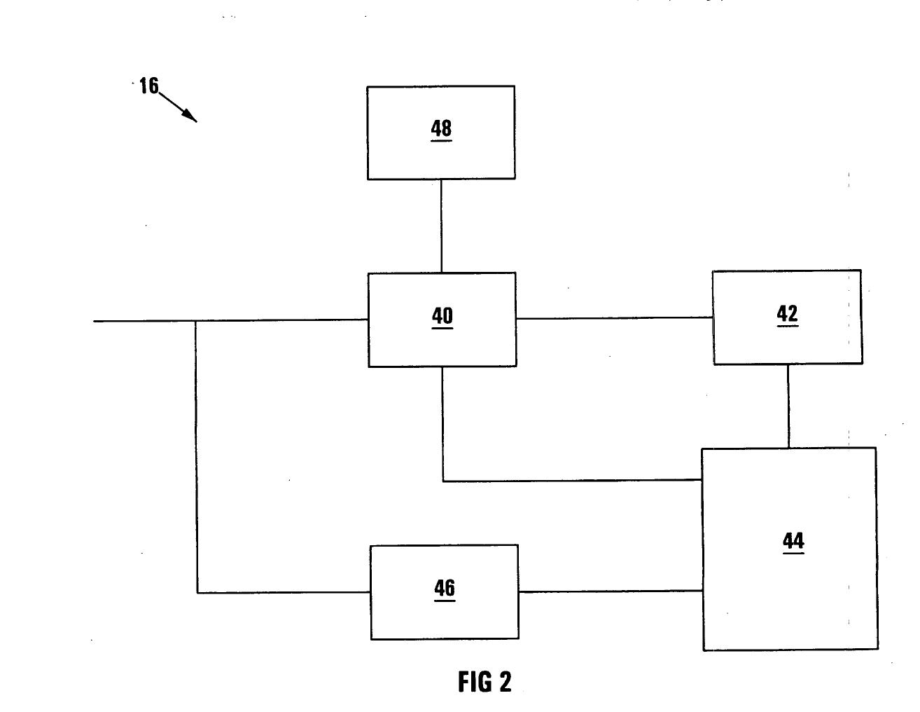

FIG. 2 is a schematic block diagram of a surveillance unit forming part of the computer equipment security system of FIG. 1; and

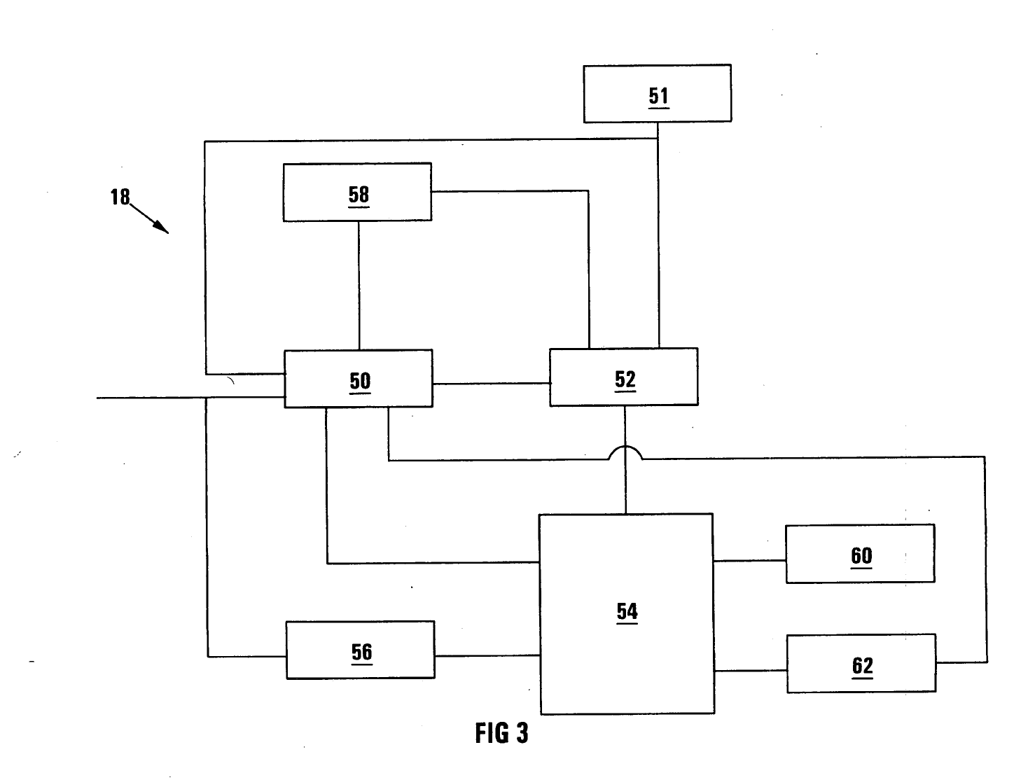

FIG. 3 is a schematic block diagram of a control station forming part of the system of FIG. 1 for controlling a plurality of the surveillance units of FIG. 2.

In the drawings, a computer equipment security system in accordance with the invention is generally indicated by reference numeral 10. The security system 10 serves to secure network equipment, such as a plurality of workstations in the form of personal computers (PCs) 12 which are connected to a data communication network. In this example, the network is a local area network (LAN) of an establishment which has a plurality of PCs 12 in distributed locations. It will be appreciated that the security system can be used to monitor or secure other computer equipment, such as network printers or other peripheral devices, in addition to the PCs 12.

The security system 10 includes a plurality of surveillance units 16 which are installed at associated PCs 12, and a control unit or control station 18 which is in data communication with the surveillance units 16 via a communication link provided by a wired link forming part of the LAN. Each surveillance unit 16 is arranged for detecting tampering with the PC 12 at which it is installed and for notifying the control station 18 of the tampering by sending an alarm signal to the control station 18.

The control station 18 includes a notification arrangement 62 for sending a notification message to predetermined recipients in response to receiving an alarm signal from one of the surveillance units 16. The notification arrangement 62 is also arranged for sending the notification message if the connection between the control station 18 and one of the surveillance units 16 is broken, for instance when the associated PC 12 is disconnected from the network.

In this example, the control station 18 includes a telephonic messaging means which forms part of the notification arrangement 62 and which notifies the recipients by sending an SMS text message to a cellular telephone 20 of each recipient over a GSM network 22. The pre-determined recipients will typically include an IT security officer, a general manager, and/or a network administrator.

The wired link by which the control station 18 and the surveillance units 16 is in communication, is provided by interception of network cables 28, 26, 30 leading from a network hub 24 to the respective PCs 12, so that the connection between the hub 24 and the surveillance unit 16 is routed through both the control station 18 and the surveillance unit 16. Each network cable 28, 26, 30 thus comprises a fly-lead 26 between the control station 18 and the surveillance unit 16, a patch cable 28 between the hub 24 and the control station 18, and a patch cable 30 between the surveillance unit 16 and the associated PC 12.

It will be appreciated that, in other embodiments of the invention, the surveillance unit can be incorporated in the motherboard of the PC by an original equipment manufacturer, which would obviate the need for the patch cable 30.

In this embodiment of the invention, each cable 28, 26, 30 comprises four pairs of conductors in the form of a CAT5 twisted line pair network cable. It is to be appreciated, however, that other types of network cables can be employed in a similar fashion in other embodiments of the invention. Two pairs of conductors are used for data communication between the PC 12 and the hub 24, and the remaining two pairs are used for connecting the control station 18 to the surveillance unit 16. It is to be appreciated that using the remaining two pairs of conductors for connection between the control station 18 and the surveillance unit 16 prevents interference of normal network operation between the PC 12 and the LAN by either the control station 18 or the surveillance unit 16.

One pair of the two remaining pairs of conductors forms a power supply conductor pair for supplying electrical power to the surveillance unit 16 from the control station 18, and the other pair of conductors forms a data communication pair for use in data communication between the control station 18 and the surveillance unit 16. Instead, in another embodiment of the invention (not shown) the two remaining pairs of conductor can both be used for data communication between the control station 18 and the surveillance unit 16.

The surveillance unit 16 (see FIG. 2) includes a RJ45 socket for receiving a RJ45 plug at an end of the fly-lead 26. The two pairs of conductors used for connecting the hub 24 to the PC 12 are extended with the patch cable 30 to a network interfacing card (not shown) of the PC 12. The power supply conductor pair feeds to a power supply regulator unit 40 for supplying regulated power to a detecting arrangement in the form of a monitoring means or unit 42 and a microcontroller unit 44. The surveillance unit 16 also includes a transceiver arrangement 46 which receives the data communication conductor pair for providing a data communication connection between the microcontroller 44 and the control station 18.

Each surveillance unit 16 is mounted inside a main case or housing of the associated PC 12, the RJ45 socket being exposed through a back plate of the PC main case. The unit 16 is in the form of a PCI card which is mounted in an open expansion slot of the PC 12.

In this example, the monitoring unit 42 includes a sensing arrangement having a sensor for detecting tampering with the PC 12, being in the form of a light sensitive switch to detect the removal or opening of the main case. It is to be appreciated that, in other embodiments of the invention, a plurality of different sensors can be used to detect tampering or attempted theft of the PC 12, e.g. by detecting removal of peripheral components of the PC 12 or movement of the PC main case.

The surveillance unit 16 also includes an alarm arrangement in the form of an onboard alarm (not shown) for generating an audible alarm if tampering with the PC 12 is detected, or if the surveillance unit is disconnected from the control station 18.

The surveillance unit 16 also comprises an onboard electrical power supply in the form of a battery 48 for supplying the surveillance unit 16 with power when the unit 16 is not powered by the fly-lead 26, such as when the fly-lead 26 is disconnected or cut.

The control station 18 (see FIG. 3) includes a connection arrangement in the form of a plurality of RJ45 sockets for connection to the fly-leads 26 of the respective PCs 12. The two pairs of conductors which are used for connecting the hub 24 to the respective PCs 12 are extended with the patch cable 28 to the hub 24, while the power supply pair is received by a power regulator unit 50 from where power is supplied to the PCs 12 over their respective fly-leads 26. Each data communication pair is received by a transceiver arrangement 56 for providing a data communication connection between the PCs 12 and the control station 18. The power regulator unit 50 receives electrical power from a mains power supply 51 for regulating and supplying electrical power to a monitoring unit 52 and a microcontroller unit 54.

In other embodiments of the invention, the control station 18 can be in the form of a stand-alone unit or a desktop unit.

The control station 18 includes a housing (not shown) which is arranged for mounting the control station 18 conveniently near the hub 24 inside a server rack or hub-cabinet, so that the control station 18 serves as a patch panel. The plurality of RJ45 sockets is exposed through the housing for receiving the RJ45 plugs of the respective fly-leads 26. It will be appreciated that the control station is located upstream of the hub 24, before any switching equipment in the network, and that the control station 18 is thus transparent to normal working of the LAN.

The control station 18 includes an onboard electrical power supply 58 in the form of a battery for supplying the control station 18 with power in the case of a mains power supply outage. The onboard electrical power supply 58 thus serves as an onboard power backup.

The monitoring unit 52 is arranged for detecting tampering with the control station 18, in a manner similar to that of the surveillance unit 16, and for detecting other conditions, such as low power supply, which warrant notification of designated persons. The monitoring unit 52 thus also monitors the mains power supply for power failure, and the battery for a battery low condition.

In conventional fashion, the microcontroller unit 54 includes a central processing unit (CPU), a RS232 serial data communications port, a LCD interface, and keypad interface which forms part of a user interface 60. The LCD and keypad, or a computer such as a portable laptop interfaced with the RS232 serial port, can be used for programming and/or configuring the microcontroller unit 54 and the surveillance units 16 which are connected to the control station 18.

Operations of the control station 18 with regard to monitoring of the surveillance units 16 and the sending of notification messages are controlled by embedded software on the microcontroller 54. This software can be adjusted by a programmer by connecting a keypad and LCD or a laptop computer to the control station 18 via the RS232 port. Naturally, access to programming of the microcontroller is password protected.

Such programming of the microcontroller will typically include inputting a number or recipient contact names and cellular telephone numbers.

The surveillance units 16 are uniquely addressable by the control station 18 and can be armed or disarmed individually from the control station 18. The control station 18 thus includes a disarming arrangement for allowing an authorised person, typically a network manager, to disarm a particular surveillance unit 16 for allowing maintenance or removal of the PC 12 without triggering an alarm. Similarly, the authorised person can arm the particular surveillance unit 16. The surveillance units 16 can thus be selectively switched between an armed condition and an unarmed condition.

In another embodiment of the invention, the control station 18 can be interfaced over the LAN or an external network for allowing remote configuration and/or programming of the microcontroller unit 54, thus permitting remote arming or disarming of the surveillance units 16. In particular, the embedded software can be accessed remotely for upgrade and controlling purposes through the GSM module 62.

The control station 18 includes a notification arrangement 62 for notifying designated or predetermined recipients of the generation of an alarm by the system 10. The notification arrangement 62 includes a GSM modem for sending a pre-programmed SMS text message over a GSM network to the cellular telephones 20 of the recipients. The text message will typically include a text string which is programmed into the microcontroller unit 54. The text message includes text for identifying a location of a PC 12 at which the alarm was triggered.

In another embodiment of the invention, the GSM module 62 can be interfaced with the LAN or an external network for sending a notification message to pre-established addresses, either over the LAN or via an external network, such as the Internet.

The microcontroller unit 54 of the control station 18 also serves as a data acquisition system for automatically logging data and storing information of events which occurs in use. Such historical data are stored on a memory device (not shown) which is in data communication with the microcontroller unit 54.

In use, when a user wishes to secure a PC 12 against tampering and theft, a surveillance unit 16 is installed in the main case of the PC. The patch cable 30 is connected between the surveillance unit 16 and the network interface card of the PC 12. A fly-lead 26 is provided for connecting the surveillance unit 16 to the control station 18, which in turn is then connected with a patch cable 28 to the hub 24.

A network manager then connects a keypad and LCD or a laptop to the RS232 port of the microcontroller unit 54 and configures the control station 18 to recognise the surveillance units 16 which are connected to the control station 18. The user decides on a text string which is programmed into the microcontroller, which text string is associated with the PC 12 so that a normal location of the PC 12 can be identified by the text string.

When an unauthorised person opens the main case of one of the PCs 12, possibly to remove components inside the case, the monitoring unit 42 of the surveillance units 16 detects that a cover of the PC main case is removed or opened without authorization. The unit 16 thus automatically triggers an alarm and generates a 97 dB alarm sound, so that the unit 16 serves as a screamer. An alarm signal is simultaneously sent via the fly-lead 26 to the control station 18, in response to which the control station 18 sends an SMS notification message to all designated recipients.

The control station 18 continuously monitors the connection with the respective surveillance units 16, and automatically triggers the alarm if the data connection is lost between any of the surveillance units 16 and the control station 18. When a prospective thief thus disconnects the network cable 26 from a PC 12 which is to be stolen, or cuts the cable 26, the control station 18 automatically generates an alarm and sends SMS notification messages to the cellular telephones 20 of a number of designated persons. The surveillance unit 16 also automatically produces its audible alarm in response to such disconnection of the associated PC 12.

If an authorised person needs to remove one of the PCs 12 or to open a PC's main case for repairs or maintenance, a network manager is requested to disarm that PC 12. The network manager then connects either a laptop or a keypad and an LCD, whichever the case may be, to the control station 18 and disarms the surveillance unit 16 which is associated with the PC 12. After completion of maintenance or repairs, the network manager arms the surveillance unit 16 again, so that the PC 12 is secured again.

From time to time, the network manager can download logged information from the control station 18 to view events which occurred with regard to securing of the PCs 12, e.g. to investigate date stamps of when respective PC surveillance units 16 were armed or disarmed, and to study a history of triggered alarms.

If the number of PCs 12 which are to be monitored exceeds the capacity of the control station 18, a similar slave unit can be connected to the control station 18 for receiving fly-leads 26 from additional PCs 12.

It is an advantage of the system 10 as described with reference to the drawings that it provides for improved security of network equipment, when compared to conventional security systems. The operation of the control station 18 permits central control of surveillance units 16 at respective PCs 12.

Use of existing LAN cabling by use of unutilized conductors on LAN cables minimises additional infrastructure required to implement the system 10 in an existing network. The control station 18 is invisible or transparent to the normal working of the network, and can conveniently be employed as a patch panel.

1. A computer equipment security system for securing computer equipment connected to a data communication network, the security system including: a plurality of surveillance units connected to respective computer devices forming part of the data communication network; a control station which is in communication with each surveillance unit, the control station being arranged for generating an alarm in response to interruption of the communication between the control station and any one of the surveillance units.

2. A system as claimed in claim 1, which includes a notification arrangement for automatically sending a notification message in response to the generation of an alarm by the control station.

3. A system as claimed in claim 2, in which the notification arrangement includes a telephonic messaging means for sending a telephonic text message to predetermined recipients.

4. A system as claimed in claim 1, in which the control station is in communication with each surveillance unit via a communication link, the control station being configured for automatically generating the alarm when the communication link is disconnected.

5. A system as claimed in claim 4, in which the communication link between each surveillance unit and the control station is a wired link provided by a security network separate from the data communication network.

6. A system as claimed in 4, in which the communication link between each surveillance unit and the control station is a wired link provided by the data communication network.

7. A system as claimed in claim 6, in which the data communication network includes a plurality of multi-line cables connecting the control station to the respective surveillance units and/or computer devices, communication between the control station and the surveillance units being performed over spare conductors of the cables, the spare conductors not being used for the transmission of data by the data communication network.

8. A system as claimed in claim 7, in which each multi-line cable comprises four twisted line pairs, two of the pairs being connected for the transmission of data by the data communication network, and the remaining two pairs connecting the control station to the respective surveillance units.

9. A system as claimed in claim 8, in which one of the line pairs provides the respective surveillance units with electrical power, the other pair being connected for communication between the control station and the surveillance units.

10. A system as claimed in claim 1, in which each surveillance unit is connected to an associated personal computer at a workstation remote from the control station.

11. A system as claimed in claim 10, in which each surveillance unit includes a sensing arrangement for detecting tampering with the associated workstation, each surveillance unit further including an alarm arrangement for sending an alarm signal to the control station in response to detecting tampering with the associated workstation.

12. A system as claimed in claim 11, in which the control station is arranged for generating an alarm either if it receives an alarm signal from one of the surveillance units, or if there is an interruption in communication between the control station and any one of the surveillance units.

13. A system as claimed in claim 11, in which the alarm arrangement is configured for producing an audible alarm at the workstation, when tampering with the workstation is detected by the sensing arrangement.

14. A system as claimed in claim 11, in which each surveillance unit includes an onboard power backup for supplying electrical power to the sensing arrangement and the alarm arrangement if a main power supply to the surveillance unit fails.

15. A system as claimed in claim 11, in which each surveillance unit is operable between, on the one hand, an armed condition in which an alarm is automatically generated in response to detection of tampering with the workstation and/or a break in communication between the surveillance unit and the control station, and, on the other hand, an unarmed condition.

16. A system as claimed in claim 15, in which the alarm arrangement is arranged to produce an audible alarm if communication between the surveillance unit and the control station is interrupted while the surveillance unit is in its armed condition.

17. A system as claimed in claim 15, in which the control station includes a disarming arrangement for permitting remote switching of the respective surveillance units between their armed conditions and unarmed conditions, to enable performance of authorised maintenance of workstations without triggering an alarm.

18. A system as claimed in claim 1, in which the control station is connected in-line between the surveillance units and a hub of the data communication network.

19. A system as claimed in 18, in which the control station is arranged for serving as a patch panel.

20. A surveillance unit for a workstation connected to a data communication network, which surveillance unit includes:
an alarm arrangement which is operable between an armed condition and a disarmed condition;
a switching means for switching the alarm arrangement between its armed condition and its unarmed condition; and
a network connection arrangement for providing a data communication connection between the switching arrangement and a remote control station, to permit switching of the alarm arrangement between its armed condition and its disarmed condition from the control station.

21. A surveillance unit as claimed in claim 20, which includes a detection arrangement for detecting tampering with the workstation, the alarm arrangement being arranged for automatically generating an alarm in response to the detection of tampering with the workstation.

22. A surveillance unit as claimed in claim 21, in which the alarm arrangement is arranged to send an alarm signal to the control station when tampering with the workstation is detected.

23. A surveillance unit as claimed in claim 21, which includes a monitoring means for monitoring the connection between the surveillance unit and the control station, the alarm arrangement being configured for generating an alarm in response to disruption of said connection.

24. A surveillance unit as claimed in 21, in which the alarm arrangement is configured to generate an alarm in the form of an audible alarm at the workstation.

25. A control station for a computer equipment security system, which control station includes:
a connection arrangement for connecting the control station to a plurality of surveillance units which are connected to respective computer devices forming part of a data communication network; and
a notification arrangement for notifying at least one predetermined recipient in response to interruption of communication between the control station and one of the surveillance units.

26. A control station as claimed in claim 25, in which the notification arrangement is additionally arranged to notify at least one predetermined recipient in response to reception by the control station of an alarm signal from one of the surveillance units.

27. A control station as claimed in claim 26, which includes a disarming arrangement for selectively switching the respective surveillance units between an armed condition and an unarmed condition.

28. A control station as claimed in claim 27, in which the notification arrangement is arranged for sending a notification message in the form of a telephonic text message.

29. A method of securing a plurality of computer devices which are connected to a data communication network, which method includes:
providing a surveillance unit at each computer device which is to be secured, each surveillance unit being in communication with a central control station; and
monitoring communication between the control station and the surveillance units; and
automatically generating an alarm in response to an interruption in communication between any of the surveillance units and the control station.

30. A method as claimed in claim 29, which includes detecting tampering with any of the computer devices by operation of the respective surveillance unit, and sending an alarm signal to the control station in response to the detection of such tampering.

31. A method as claimed in claim 29, in which generating an alarm includes generating an audible alarm at the relevant computer device.

32. A method as claimed in claim 29, which includes switching a particular surveillance unit from an armed condition to an unarmed condition if authorised removal of or maintenance to the associated computer device is to occur.

33. A method as claimed in claim 29, in which generating of the alarm includes sending a notification message to at least one predetermined recipient.

34. A method as claimed in claim 33, in which the notification message is in the form of a telephonic text message sent via a cellular telephone network.

35. A method as claimed in claim 29, which includes connecting the control station to respective surveillance units by use of existing data communication network infrastructure, using spare conductors on network cables for communication between the control station and the surveillance units.
